(19) United States
(12) Patent Application Publication
(10) Pub. No.: US 2008/0043461 A1
(43) Pub. Date: Feb. 21, 2008

(54) Electronic Flame Analogy Device of Incense Canister

(76) Inventor: Ming Ren XIAO, Humen Zhen (CN)

Correspondence Address: Dr. BANGER SHIA, 102 Lindencrest Ct, Sugar Land, TX, 77479-5201, US

(21) Appl. No.: 11/462,987

(22) Filed: Aug. 7, 2006

(51) Int. Cl. F21V 35/00

(52) U.S. Cl. 362/161

(57) ABSTRACT

An electronic flame analog installation for incense wax canister providing better light-emitting results, compact structure among members, simple construction and powerful utility includes a lampshade containing an electronic light emitting installation; and a lamp holder disposed to the lower end of the lampshade to accommodate the tip of the lampshade to adapt to the tip of the incense wax canister; the lamp holder and the top of the canister being effectively fixed and connected to each other; and the built in electronic light-emitting installation produces electronic flame to provide the canister better flame imitation results.

### BACKGROUND OF THE INVENTION

(a) Field of the Invention

The present invention is related to an electronic flame analog installation, and more particularly, to one applied in an incense wax canister to imitate the decoration results.

(b) Description of the Prior Art

In the incense wax canisters generally available in the market, the flame comes from burning a candle or a torch. Any act of omission during the use may well wind up accident since the fire is live. Production of smoke and dust in the course of combustion will also cause contamination to fail in providing a better living space and working environment for people. Accordingly, various improvements involving substitute the live fire with a flame simulator, i.e., replacing the conventional flame with analog electronic flame. An electronic candle construction disclosed in Chinese Utility Patent CN2600293Y is comprised of a lampshade pervious to light and containing a chamber, a locking seat is provided in the chamber, and a light emitting device is disposed on the locking seat with the primary purposes of becoming more attractive for the electronic candle and allowing it be firmly placed on a table. The electronic candle however provides a single function and prevents it from being adapted to other structures for use.

An electric lighting flame simulator disclosed in U.S. Pat. No. 6,719,443 relates a construction of two power sources, IC circuit, and another power source supplying power to the IC circuit. The IC circuit intermittently lights up one of multiple light sources that is independent from other power sources for each power source all together to provide flaring motion results as applied in clothes and shoes for decorative, lighting or alert results. However, the electric lighting flame simulator taught in U.S. Pat. No. 6,719,443 is comparatively tedious in the assembly of its structural members.

As more and more incense wax canisters are introduced into the market, the incense is evaporated to emit its fragrance by heating the canister for compliance with user safety and environmental requirements at the cost of the atmosphere of the flame produced in the combustion of the conventional incest wax. Therefore, it usually warrants certain electronic flame for decoration by imitating the live flame. However, the technical options of those patents cited above fail to be effectively adapted to the incense wax canister for achieving flame imitation purpose; and certain flame simulators available in the market simply fail to jointly operate with incense wax canister.

### SUMMARY OF THE INVENTION

The primary purpose of the present invention is to provide an incense wax canister electronic analog installation to be effectively fixed over the canister for a built-in electronic light emitting installation in the present invention to achieve better flame imitation effects by producing an electronic flame.

Another purpose of the present invention is to provide an incense wax canister electronic analog installation to improve its light-emitting results and to secure a compact assembly among members by way of an improved electronic light-emitting structure.

To achieve the purpose, the present invention includes a lampshade, an electronic light emitting installation built in the lampshade, and a lamp holder fixed to the lower end of the lampshade to fit the tip of the canister.

The lamp holder includes a holder to be adapted to the lampshade. The holder is provided with a through hole to accommodate the electronic light emitting installation and a locking member protrudes from where below the holder to lock the tip of the incense wax canister.

The locking member is related to a locking ring or is comprised of multiple locking poles spaced at intervals.

The electronic light emitting installation includes a cell holder and a lid. The cell holder contains cell box and PCB; and a light-emitting device powered by the cell is disposed on the PCB. The battery holder is comprised of a base plate and a hollow post upwardly extending and penetrating through the base plate. A light pervious hole is disposed on the hollow post. The cell is installed in a locking post, and the locking post is fixed to PCB and inserted into the hollow post. A stud is disposed on the top of the locking post to engage in a locking hole provided on the top of the hollow post to better secure the cell and the PCB firmly in the hollow post. The lid is disposed in the lower part of the hollow post to lock up the base plate of the cell holder by means of a locking member disposed on the perimeter of a base cover.

When compared to the prior art, the present invention allows effective engagement and connection between the lamp holder disposed to the lower end of the lampshade and where above the incense canister for the incense wax canister to yield better flame imitation results through the electronic flame produced by the built-in electronic light emitting installation. Furthermore, the improved construction of the electronic light emitting installation in the present invention provides better light-emitting results, inter alia, a compact adaptation among the structural members for the present invention to feature simple construction and powerful utility.

### BRIEF DESCRIPTION OF THE DRAWINGS

FIG. 1 is an exploded view of the present invention.

FIG. 2 is an upward view showing an assembly of the present invention.

FIG. 3 is a sectional view of a lampshade and a lamp holder of the present invention.

FIG. 4 is a schematic view showing an assembly of the lampshade and the lamp holder taken from FIG. 3.

FIG. 5 is a sectional view showing that the present invention is applied on an incense wax canister.

FIG. 6 is an exploded view showing the construction taken from FIG. 5.

### DETAILED DESCRIPTION OF THE PREFERRED EMBODIMENTS

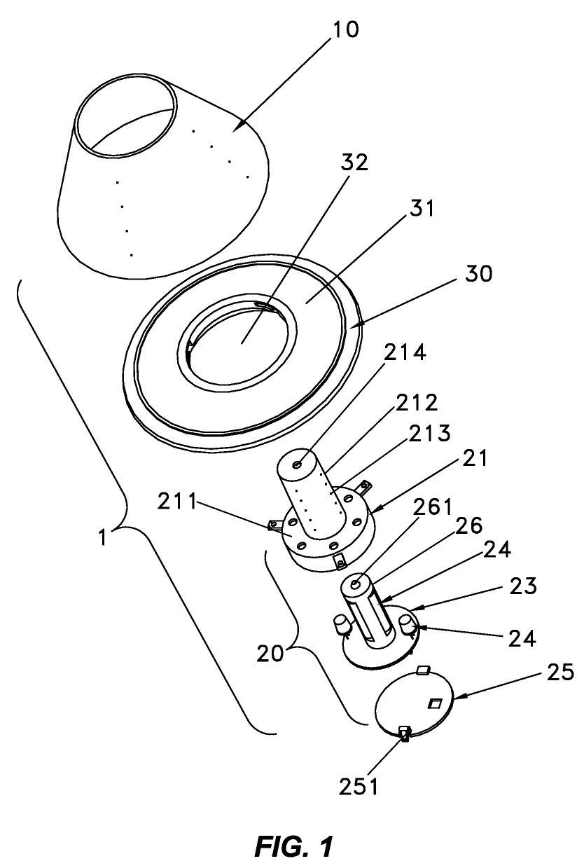

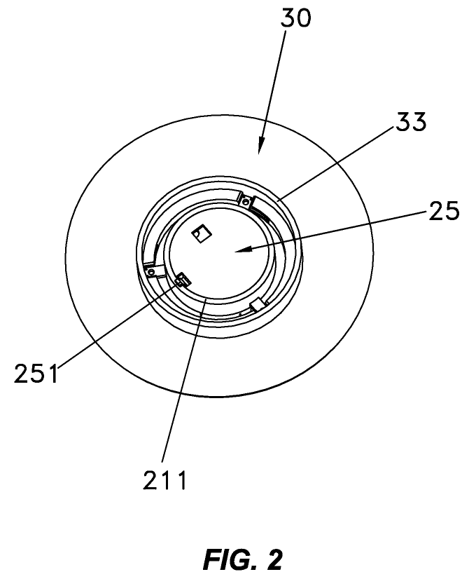

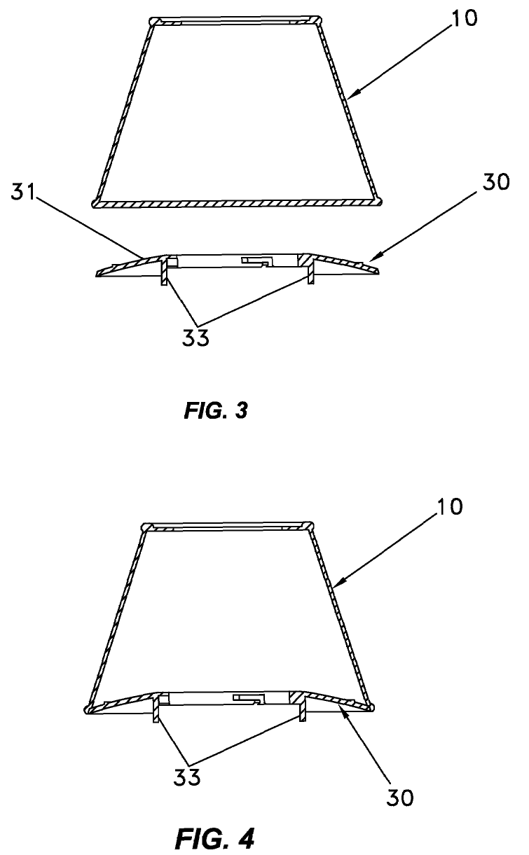

Referring to FIGS. 1 through 5, an electronic flame analogy device 1 for incense wax canister includes a lampshade 10 and an electronic light emitting installation 20 contained in the lampshade 10. A lamp holder 30 to be adapted to the tip of the incense wax canister is fixed to the lower end of the lampshade 10.

The lamp holder 30 includes a holder 31 adaptable to the port of the lampshade 10. A through hole 32 to accommodate the electronic light emitting installation 20 is disposed on the holder 31. A locking member 33 protruding from where below the holder 31 is provided to contain the tip of the tip of the incense wax canister. The locking member 33 relates to a locking ring; or alternatively, the locking member 33 may be comprised of multiple locking poles spaced at intervals.

The electronic light emitting installation 20 includes a cell holder 21 and a lid 25. The cell holder 21 contains a cell box 22 and a PCB 23, and a light-emitting device 24 powered by the cell 22 is disposed on the PCB 23. The cell holder 21 is comprised of a base plate 211 and a hollow post 212 upwardly extending and penetrating through the base plate 211. A light pervious hole 213 is disposed on the hollow post 212 so the streams of light are eradiated through the light pervious hole 213 on the hollow post 212 from the light-emitting device 24 to create analog electronic flame. The cell 22 is installed in a locking post 26 fixed to the PCB 23 and inserted into the hollow post 212. A stud 261 is disposed on the top of the locking post 26 to be engaged with a locking hole 214 disposed on the top of the hollow post 212 so to better secure both of the cell 22 and the PCB 23 firmly in the hollow post 212. The lid 25 is disposed in the lower port of the hollow post to seal up the hollow post 212. Wherein, the lid 25 is secured in position by the interference of a locking tab 251 disposed on the perimeter of the lid 25 engaged with the base plate 211 from the cell holder 21 while locating on the same plane with the bottom of the base plate 211.

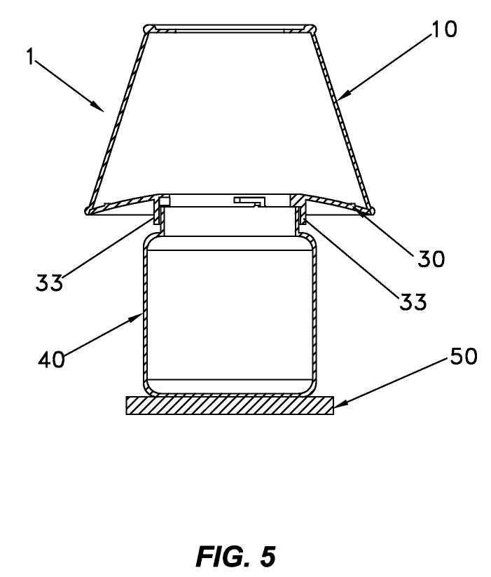

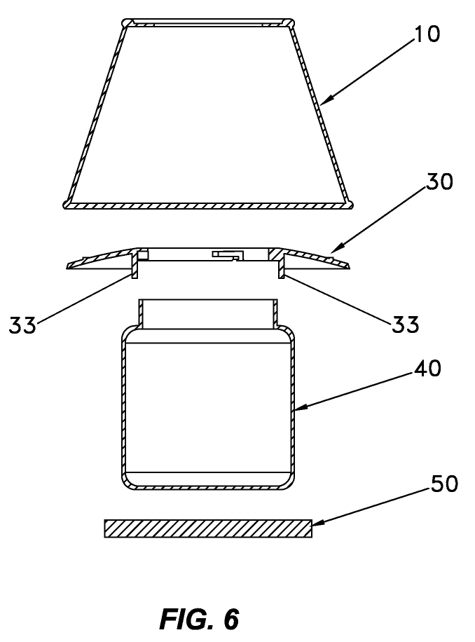

As illustrated in FIGS. 5 and 6 showing applications of the present invention adapted to the incense wax canister, the electronic flam analog installation 1 is comprised of the lampshade 10, the light emitting installation 20, and the lamp holder 30 and mounted to the top of an incense wax canister 40. A heater 50 disposed at the bottom of the incense wax canister 40 to heat up and evaporate the incense wax. The heating process and the evaporation relate to the prior art and will not be elaborated herein. The present invention is characterized in that the lamp holder 30 of electronic flame analog installation 1 is directly connected to the tip of the incense wax canister 40 and secured in place by the interference created when the locking member 33 from the lamp holder 33 is contained by the outer wall of the tip of the incense wax canister 40, thus to effectively guarantee the assembly of the present invention on the top of the incense wax canister 40 for yielding better flame imitation results. Meanwhile, the electronic light emitting installation 20 is installed by means of the cell 22 and the PCB 23 in the hollow post 212 of the cell holder 21. The lid 25 encloses the port of the hollow post 212 and locks up the base plate 211 of the cell holder 21 while locating on the same plane with the bottom of the base plate 211 thus to achieve a compact adaptation among structural members of the present invention. To better secure both of the cell 22 and the PCB 23 firmly in the hollow post 212, the locking post 26 is provided on the PCB 23 to accommodate the installation of the cell 22 before inserting the locking post 26 into the hollow post 212 while having the stud 261 to engage the locking hole 214 disposed on the top of the hollow post 212. Furthermore, streams of light eradiated from the light pervious hole 213 on the hollow post 212 provide better light-emitting results. Accordingly, the present invention is simple in construction yet providing powerful utility.

The prevent invention provides an improved structure of an electronic flame analog installation for incense wax canister, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An electronic flame analog installation for incense wax canister includes a lampshade containing an electronic light emitting installation; and a lamp holder disposed to the lower end of the lampshade to accommodate the tip of the lampshade to adapt to the tip of the incense wax canister.

2. The electronic flame analog installation for incense wax canister as claimed in claim 1, wherein the lamp holder includes a holder adaptable to the port of the lampshade; a through hole being disposed to the holder to secure the electronic light emitting installation; and a locking member protruding from where below the holder to lock up the tip of the incense wax canister.

3. The electronic flame analog installation for incense wax canister as claimed in claim 2, wherein the locking member relates to a locking ring 1 or is comprised of multiple locking poles spaced at intervals.

4. The electronic flame analog installation for incense wax canister as claimed in claim 1, wherein the electronic light emitting installation includes a cell holder and a lid adapted to the cell holder; the cell holder contains a cell and a PCB; and a light-emitting device powered by the cell is disposed on the PCB.

5. The electronic flame analog installation for incense wax canister as claimed in claim 4, wherein the cell holder is comprised of a base plate and a hollow post upwardly extending from and penetrating through the base plate; and a light pervious hole is disposed on the hollow post.

6. The electronic flame analog installation for incense wax canister as claimed in claim 5, wherein a cell is installed in a locking post and the locking post is fixed to the PCB and inserted into the hollow post.

7. The electronic flame analog installation for incense wax canister as claimed in claim 6, wherein a stud is disposed on the top of the locking post to engage a locking hole disposed on the top of the hollow post.

8. The electronic flame analog installation for incense wax canister as claimed in claim 5, wherein the lid is disposed in the lower port of the hollow post and locked to the base plate of the cell holder by means of a locking member disposed on the perimeter of the lid.
